(19) United States
(12) Patent Application Publication
(10) Pub. No.: US 2007/0294005 A1
(43) Pub. Date: Dec. 20, 2007

(54) Device And Method For Monitoring The Filling Level Of A Coolant Circuit Of A Vehicle Air Conditioning System

(76) Inventor: Christian Kerschl, Rosenfeld (DE)

Correspondence Address: CROWELL & MORING LLP;INTELLECTUAL PROPERTY GROUP, P.O. BOX 14300, WASHINGTON, DC, 20044-4300, US

(21) Appl. No.: 11/596,881

(22) PCT Filed: May 4, 2005
(86) PCT No.: PCT/EP05/04812

§ 371 Date: Jul. 11, 2007

(30) Foreign Application Priority Data
May 18, 2004 (DE) 10 2004 024 579.7

(51) Int. Cl. G05D 9/00; G01F 23/00

(52) U.S. Cl. 701/36; 701/29; 701/33; 73/290 R

(57) ABSTRACT

In a method and a device for monitoring a filling level of a coolant circuit of a vehicle air conditioning system, an external temperature and/or an engine temperature of the vehicle and a coolant pressure are measured and a resting state analysis of the coolant quantity is carried out. Control, events for operating the coolant circuit and/or warning events are controlled when an incorrect quantity is detected. To improve the reliability of the information provided by the resting state analysis, the duration taken to reach a homogenous thermal state of the vehicle is defined, or the homogenous thermal state of the vehicle is detected as a function of at least one measured temperature (tₐ, tₘ). The, resting state analysis is carried out, or the control events during the operation of the coolant circuit and/or warning events in the vehicle are controlled, as a function of the defined or detected homogenous thermal state of the vehicle.

### BACKGROUND AND SUMMARY OF THE INVENTION

This application claims the priority of German patent document 10 2004 024 579.7, filed May 18, 2004 (PCT International Application No. PCT/EP2005/004812, filed May 4, 2005), the disclosure of which is expressly incorporated by reference herein.

The invention relates to a method and a device for monitoring the filling level of a coolant circuit of a vehicle air conditioning system.

German patent document DE 100 61 545 A1 discloses a method of the generic type, in which the coolant pressure and a temperature are measured in the stationary state of the coolant circuit. It is concluded that incorrect filling has occurred if the ratio of the pressure and temperature does not lie within a specific tolerance range.

One object of the present invention is to provide a method and apparatus that utilize measured temperature values from existing temperature sensors to monitor the fill level in the coolant circuit of a vehicle air conditioner, while largely excluding incorrect results.

These and other objects and advantages are achieved by the method and apparatus according to the invention, in which coolant pressure is measured in the coolant circuit of a vehicle air conditioning system of a motor vehicle, and in addition an external temperature is measured at the air surrounding the vehicle and/or an engine temperature is measured at the drive assembly of the vehicle. The external temperature can be measured, for example, by an external temperature sensor of the vehicle such as is conventionally included as part of the customary basic equipment of motor vehicles. For example the coolant temperature sensor or the lubricant temperature sensor of the drive assembly are available for measuring engine temperature.

In order to carry out a resting state analysis of the coolant circuit and to detect an incorrect quantity in the coolant circuit, coolant pressure is measured by a pressure sensor and related to the temperature of the coolant or a corresponding temperature. By evaluating measured or calculated state variables within the scope of the relationship or afterwards it is possible to draw conclusions regarding the filling level of the coolant circuit (that is, the coolant quantity located in the volume of the coolant circuit).

The mathematical conversion of the establishment of a relationship between the value pair of a coolant pressure and an assigned temperature with subsequent evaluation can be done in various ways. For example, a coolant pressure tolerance range necessary for operating the air conditioning system is defined for a measured temperature value by means of a predefinition algorithm, and an evaluation algorithm is used to determine whether the measured coolant pressure lies within this tolerance range. The minimum coolant quantity and maximum coolant quantity which define the associated tolerance range, and the coolant pressure levels which occur with these quantities in a given coolant circuit, must be determined as the limiting curves of the tolerance range in a coolant circuit specific fashion as a function of the temperature.

Alternatively, it is possible, for example, to define an associated saturation temperature for the measured pressure value. In order to evaluate the measured temperature value, the evaluation algorithm is then used to check whether it is higher than the value of the saturation temperature that is assigned to the pressure. Incorrect quantities can also be detected within the scope of the resting state analysis if the measured coolant pressure drops below a minimum pressure level or exceeds a maximum pressure level.

The resting state analysis of the filling level of the coolant circuit is thus performed by establishing a relationship between a temperature value and the value of the coolant pressure, and detecting the operating quantity (or an incorrect quantity) subsequent to the evaluation of the relationship. What is referred to as the meeting of detection processes in the method thus means the mathematical evaluation of parameter values by means of an evaluation algorithm. The result of such a detection is a switching process which is dependent on the result of the evaluation algorithm. This can include, for example, the setting of flags on a data bus or specific switching or controlling processes at devices of the vehicle. When a predefined correct operating quantity of the coolant circuit is determined, the device for carrying out the method remains passive, and permits normal operation of the coolant circuit when the drive assembly is started.

The detection of an incorrect quantity in the coolant circuit is controlled or switched as a result of the detection of control events during the operation of the coolant circuit and/or warning events at the vehicle. In the process, control events during the operation of the coolant circuit can include, for example, reduction or blocking of the delivery operation of the coolant compressor. Furthermore, or alternatively, it is possible, for example, to activate audible or visual warning signals in the vehicle.

Vehicles can be equipped with a temperature sensor for directly sensing the coolant temperature (for example by contact with the coolant or with coolant-conducting elements) or with a temperature sensor for indirectly sensing the coolant temperature (for example for measuring a heat exchanger air temperature downstream of one of the heat exchangers of the coolant circuit). If a vehicle does not have such a temperature sensor for sensing the coolant temperature itself, it must be taken into account that there are considerable temperature differences between the coolant at various locations in the coolant circuit on the one hand and the media measured at the respective installation locations of the sensors by the other temperature sensors of the vehicle while the vehicle is operating and in a run-on time after the vehicle has been shut down, with the drive assembly switched off. When the relationship between the measured coolant pressure and the temperature value of the temperature measuring location which is correctly evaluated for the resting state analysis by means of the difference between this temperature value and the actual coolant temperature, excessively high resting state temperature differences between the coolant and the medium at this measuring location give rise to an incorrect interpretation and incorrect detection of the filling level of the coolant circuit.

According to the present invention, either no resting state analysis is carried out within the run-on time after the vehicle has been shut down, or else any detection which is carried out in the resting state analysis has no effect during the control of the coolant circuit or at the warning devices of the vehicle. This is achieved by virtue of the fact that the resting state analysis (or the coolant circuit switch events or warning device switch events which are dependent on the detection of said analysis) is carried out as a function of a homogenous thermal state of the vehicle. The “thermal homogeneity” of the vehicle is to be understood here as a relative term which indicates that the temperatures of certain locations or media in or on the vehicle are within permitted tolerance ranges. Thermal homogeneity of the vehicle is detected or defined by the method and/or apparatus according to the invention. A homogenous thermal state from the point of view of the method exists when thermal homogeneity is detected in the sense that, after measured variables have been evaluated (in particular temperatures values at different temperature measuring locations), a corresponding state identifier is set to “true” or corresponding subordinate method steps are enabled.

When the thermal homogeneity is defined, the homogenous thermal state is given if a condition on at least one indirectly temperature-dependent (or temperature-dependently) defined characteristic variable is met. This characteristic variable can be a coupled state variable such as, for example, a coolant temperature which must lie within a given tolerance band. However, the characteristic variable can also be a point in time or a duration which are calculated, for example, after the drive assembly has been switched off as a function of measured values (such as the coolant temperature), with the condition being that this point in time is reached or that the corresponding duration has expired. If a homogenous thermal state is defined, there is provision in particular for the duration of the run-on time to the time when a homogenous thermal state of the vehicle is reached to be calculated or determined as a function of at least one measured temperature.

It is also possible for alternative or supplementary conditions to be defined as a function of the situation. The state variables can be made available directly as measured values of the sensors or as state variables which are made available on a bus system. The run-on duration can be defined here as a function of various parameters which are available at the vehicle as measured variables. In the simplest case, the run-on duration is defined as a function of at least one temperature value such as, for example, the external temperature or an engine temperature. In order to improve the method quality, it is possible to consider combining these two temperatures and additional parameters such as, for example, a solar radiation parameter in characteristic diagrams. The parameter-dependent cooling behavior of the vehicle has been determined in advance in measuring series.

If a homogenous thermal state is detected, a measured temperature (but advantageously a temperature difference between two measured temperatures) is checked by reference to a predefined, admissible value range. In the simplest case, the detection of a homogenous thermal state of the vehicle is determined by reference to a measured temperature value such as, for example, an engine temperature, or the detection is carried out by the evaluation of said temperature. It is thus possible to detect a homogenous thermal state, for example as soon as the engine temperature has reached a plausible ambient temperature level. A particularly reliable detection of a homogenous thermal state of the vehicle can advantageously be carried out by comparing two temperature values such as, for example, the external temperature and the engine temperature, which approach one another as a result of thermal homogenization. The evaluations of the temperature value, or of the various underlying temperature values, are carried out as a function of further parameters such as, for example, solar radiation. The evaluation criteria for detecting a homogenous thermal state have to be determined in advance with the testing equipment in a vehicle-specific and coolant circuit-specific fashion.

The evaluation or effectiveness of the resting state analysis, which is dependent on the homogenous thermal state being reached, ensures that, on the one hand, when incorrect measured temperature values are present the filling level of the coolant circuit either is not checked or does not have any effect; but on the other hand the resting state analysis is carried out as often as possible since without such preliminary checking, there is either frequent checking and malfunctions are permitted or malfunctions are suppressed and measured only rarely. The method or apparatus according to the invention increases the reliability of the information regarding the filling level of the system by using a resting state analysis, and also permits the largest possible number of informative checks.

The homogenous thermal state of the vehicle also means that the measured value of an existing temperature measuring location can be evaluated for the calculations, as an equivalent coolant temperature value within the scope of the resting state analysis. When the vehicle is thermally homogenous, it is thus possible to assume with sufficient certainty that, depending on the arrangement of the assemblies of the vehicle and specifically of the coolant circuit, an engine temperature or the external temperature will have only a small deviation from the coolant temperature. Such an assumption cannot be made with sufficient certainty without verification of homogenization according to the invention.

In order to achieve a method which is sparing in terms of computational capacity, in one embodiment of the method a run-on duration for reaching a homogenous thermal state of the vehicle is defined on the basis of the measured external temperature. In order to ensure maximum method quality, an external temperature-dependent minimum homogenization duration is determined taking into account maximum engine heating. As an equivalent to this, a homogenous thermal point in time which corrects with respect to this duration can be determined. This embodiment of the method provides a very simple way of estimating a duration for reaching an ensured homogenous thermal state of the vehicle, by virtue of an engine temperature which is constant after a relatively short operating duration of the drive assembly of the vehicle and an external temperature which varies depending on the climate zone and weather conditions.

In one particular embodiment of the method, the measured engine temperature value is used to determine a thermal homogenization duration. In this context it is possible in particular to estimate more reliably relatively short run-on times in order to reach a homogenous thermal state such as, for example, after relatively short distances and thus a small degree of heating the engine. This evaluation can be carried out in particular as an additional engine-temperature-dependent evaluation in addition to an external-temperature-dependent evaluation at the vehicle. In this context it is possible, for example after a short travel time, to define a run-on duration as a function of the engine temperature, and a run-on duration can be defined purely as a function of the external temperature after a relatively long travel time.

In one particular refinement of the method according to the invention, a homogenous thermal point in time is defined directly after the drive assembly has been switched off. If the vehicle (for example the drive assembly), is not started again until after this point in time, the resting state analysis of the filling level of the coolant circuit can be carried out when this point in time is reached or subsequently when the vehicle is activated or started. Depending on the evaluation of the resting state analysis, the coolant circuit is put into operation given permissible operating quantities; or in the case of incorrect quantities it is operated with reduced power, switched off or corresponding warning events are actuated.

In order to ensure a high degree of method quality, in one particular embodiment of the invention the homogenous thermal point in time is defined in the stationary state of the vehicle continuously or repetitively after a time interval has expired. As a result, parameters which change during the run-on duration, such as for example reduction in the external temperature at night, can be taken into account.

In another embodiment of the invention, the resting state analysis of the filling level of the coolant circuit is preceded by a homogenization analysis of the temperatures of the vehicle. In this context, in particular the relationship is evaluated between the engine temperature and the external temperature on the vehicle (for example the difference or quotient of said temperatures), and temperature homogenization of the vehicle is detected as a function of this evaluation. The detections of the homogenization analysis either cause the resting state analysis to be carried out or cause corresponding intervention measures or warning measures to be actuated.

In this context, the external temperature measuring location and engine temperature measuring location (for example, the cooling water temperature measuring location) are to be used, with an alternative possibility of evaluating other temperature measuring locations (for example, in other assemblies of the vehicle). This comparative consideration of two temperature values makes it possible to detect thermal homogenization of the vehicle indirectly or even directly depending on the temperature value pair considered. As a result, a particularly high degree of reliability of the method is achieved. Furthermore, the resting state analysis can take place directly after a homogenous thermal state has been reached, and the detection which is made in said analysis about the coolant filling level can be stored. At the next engine start, the coolant circuit is then put into operation, or else it is blocked or warning events are switched.

In one particular embodiment of such a method, the homogenization analysis is carried out directly before the drive assembly is put into operation, in particular after a locking system or starting system or a system activation device of the vehicle has been actuated. The largest possible homogenization duration is ensured here, which improves the method quality. The electrical resources of the vehicle are spared by activating the homogenization analysis and subsequent or parallel resting state analysis when the vehicle is put into operation or activated.

In one embodiment of a device according to the invention, a computer, an external temperature sensor and/or an engine temperature sensor and a coolant pressure sensor are provided for monitoring a filling level of a vehicle air conditioner coolant circuit. The sensors can be connected to the computer in a way which can be analyzed. The computer performs a controlling intervention in the coolant circuit of the vehicle and/or warning devices of the vehicle. For this purpose, an algorithm for resting state analysis is stored on the computer, by which it is possible to detect incorrect filling of the coolant circuit by reference to the relationship between a coolant pressure measured at the coolant pressure sensor and a measured temperature value. The computer can switch the control interventions at the coolant circuit and/or warning events at warning devices of the vehicle, as a function of the detection of an incorrect quantity. Furthermore, an algorithm by means of which it is possible to define a homogenization duration or to detect thermal homogenization of the vehicle by reference to one of the measured temperature values.

In the device according to the invention, the resting state analysis and/or the switching of the warning events or control events are performed as a function of the detection of the thermal homogenization of the vehicle by means of the homogenization algorithm. The algorithm which is stored on the computer with temperature-dependent evaluation or definition of thermal homogenization of the vehicle and the switching and/or control of warning events or control events as a function thereof, permits an informative resting state analysis to be carried out in order to determine the filling level of the coolant circuit of a motor vehicle. Such a device is equipped by means of the selection of the temperature sensors, of the computer, its control connections and the algorithms stored on the computer for the homogenization analysis and resting state analysis, in particular in order to carry out a method according to the invention described above.

Other objects, advantages and novel features of the present invention will become apparent from the following detailed description of the invention when considered in conjunction with the accompanying drawings.

### BRIEF DESCRIPTION OF THE DRAWINGS

FIG. 1 is a flowchart of a method according to the invention;

FIG. 2 is a schematic illustration of a device according to the invention;

FIG. 3 is a diagram which illustrates schematically the relationship between the pressure quantity and coolant quantity for various system temperatures when the coolant circuit is stationary and homogenized; and

FIG. 4 is a diagram which illustrates schematically a temperature-dependent minimum pressure of a coolant circuit for detecting a minimum coolant quantity.

### DETAILED DESCRIPTION OF THE DRAWINGS

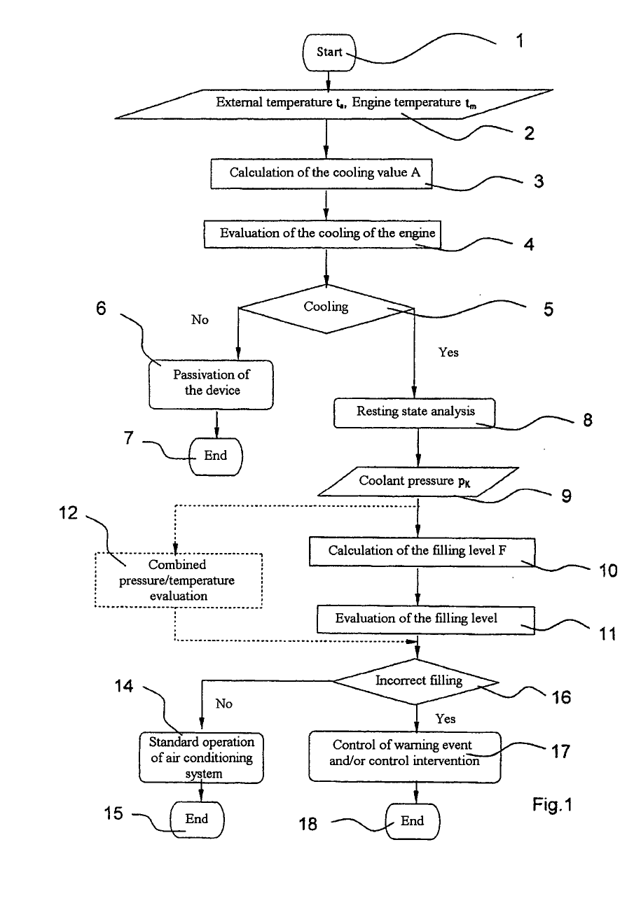

FIG. 1 is a flowchart for the method according to the invention in which at first the vehicle is cooled by reference to an external temperature of the vehicle and an engine temperature. Thermal homogenization is thus checked and a resting state analysis of the quantity in the coolant circuit is carried out by means of cooling, that is to say thermal homogenization, as a function of the detection which is carried out by means of the checking.

As shown in FIG. 1, the process is initialized by activating the vehicle, for example by actuation of the locking system. Then, in step 2, the external temperature and the engine temperature are measured preferably by existing sensors of the vehicle, and the measured values are made available for evaluation by the computer on which the corresponding, downstream method steps are to be carried out. (This can be done by directly connecting the sensors or else by means of a data bus system.) The engine temperature is preferably either the temperature of the cooling water or the temperature of the lubricant of the engine.

The next method step is calculation of the cooling value 3. In the illustrated exemplary embodiment, the temperature difference between the engine temperature and the external temperature is calculated. (Alternatively, however, it would also be possible, for example, to calculate a quotient of these temperatures or their logarithmic value.) After the cooling value has been calculated, it is evaluated by comparing it with a predefined limit cooling value which indicates a sufficient approximation of the engine temperature to the external temperature. This limit cooling value can also be variable itself as a function of other parameters such as, for example, the external temperature. During the evaluation of the cooling of the engine it is possible to conclude directly that there has been sufficient cooling of the engine if the external temperature is higher than the engine temperature, for example if the external temperatures increase at the start of a day.

When used herein, the phrases “closing at a specific state” or “detection of a specific state”, refer to a switching process, dependent on the respective state, of a state indicator or of a specific switching process. The evaluation of the cooling of the engine is followed in step 5 by the detection of the cooling yes or no 5, or the assigned switching process or control process. If in the illustrated exemplary embodiment sufficient cooling is not detected in step 5, nothing is changed in the operating state preceding the method, because when there is inadequate cooling of the engine (and there is thus associated inadequate thermal homogenization in the vehicle), it is not possible to assign a temperature value of the coolant which can be determined reliably or assigned in an equivalent fashion. Thus, a resting state analysis which is carried out by reference to such values consequently does not determine any useful value of the filling level of the coolant circuit. In the illustrated exemplary embodiment, the method is ended at point 7 after the method step for passivation of the device 6 when insufficient cooling of the engine is detected.

If it is detected in step 5, that the engine has cooled sufficiently, a resting state analysis of the filling level of the coolant circuit is initiated in step 8. In the process, the coolant pressure is first measured in step 9. Alternatively, this step can also be placed in a preceding position and can, for example, be carried out together with the measurement of the external temperature and the engine temperature in step 2 and should take place simultaneously, and at any rate in a direct sequence with the temperature measurements. If the measurement of the coolant pressure precedes the resting state analysis, the latter step 9 would include evaluation of the pressure value by the computer or reading out of the corresponding memory.

In step 10, the filling level of the coolant circuit is determined by reference to at least one temperature value such as, for example, the engine temperature (or a mean value or comparison value calculated from the external temperature and engine temperature). This is preferably done by reference to a characteristic diagram which is stored in the computer and is preferably predefined specifically for the volume of the respective coolant circuit and the associated coolant, and in which the filling level can be evaluated as a function of a pressure value and a temperature value. In the next method step 11, the filling level determined in this manner is subsequently evaluated by placing it in a qualitative relationship with a minimum limiting value and/or maximum limiting value for the filling level of the coolant circuit, a computational comparison of the values being carried out.

The method steps for the calculation of the filling level 10 and evaluation of the filling level 11 can also be replaced by an alternative method step for combined pressure/temperature evaluation 12. in this case, a limiting curve is predefined in a temperature/pressure diagram, which curve predefines the ratio of pressure and temperature in the volume of a given coolant circuit for a fixed limiting filling level. As a result, with this combined pressure/temperature evaluation 12 by reference to the measured temperature and the associated limiting pressure value which results from the limiting curve, the measured coolant pressure is evaluated in order to determine whether it exceeds or drops below this value. This combined pressure/temperature evaluation 12 or the evaluation of the filling level 11 which is carried out is followed by a process to detect whether the coolant circuit has an incorrect fling amount in step 16. If it is determined that the coolant circuit does not have an incorrect filling amount, standard operation of the air conditioning system is enabled (step 14) and the process ends at step 15.

If an incorrect filling amount 14 but an incorrect filling amount is in step 16, a warning event and/or control intervention take place in the step 17, preferably including a visual warning indication assigned to the incorrect filling with coolant, and additionally or alternatively delivery operation of the coolant compressor is switched off. The detection of an incorrect quantity in the coolant circuit is preferably stored in a memory which can only be deleted by a service operation. The intervention events and/or warning events or the storage of a fault indicator in a memory can be carried out in order to provide protection even after a certain number of confirming detections to the same effect. Likewise, detections with opposing results can cause intervention, warning or fault storage events to be cancelled or revoked in subsequently carried out measurements. The step 17 of warning and/or controlling intervention is followed by ending of the method 18.

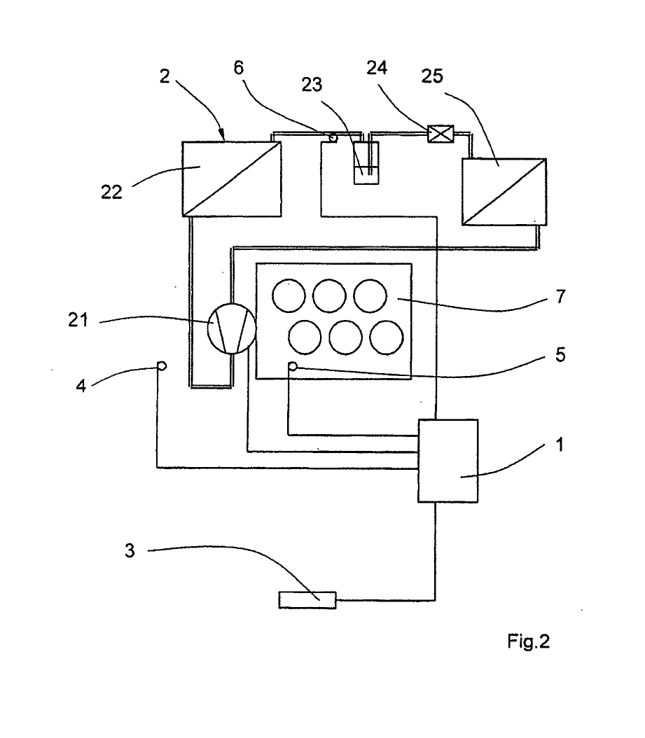

FIG. 2 is a schematic illustration of an embodiment of a device according to the invention. It includes a computer 1 to which various temperature sensors are connected in a way which can be evaluated and various assemblies are connected in a way which can be switched by the computer. The actual coolant circuit 2 of the motor vehicle has a coolant compressor 21 which is driven by the drive assembly 7 of the motor vehicle. The coolant compressor 21 feeds the coolant in the coolant circuit 2 in the direction of a downstream heat exchanger 22 which is provided for cooling the coolant and, depending on the coolant used, for condensing the coolant. By exchanging heat with external air flowing through it, the heat exchanger 22 (also referred to as a condenser or gas cooler) cools the coolant which is compressed by the coolant compressor 21.

In the exemplary embodiment shown of the coolant circuit, the coolant is directed from the heat exchanger 22 to a collector 23 which has a drying cartridge for extracting moisture from the coolant, and serves as a storage reservoir for the coolant. Through the removal opening of its outflow line, which is arranged low in the collection reservoir, the collector 23 both causes exclusively flowing coolant to flow through and causes the lubricant of the coolant circuit which is located in the lower region of the collector 23 to flow through. The lubricant is provided for lubricating the moving parts of the coolant compressor 21 and is also conveyed in the coolant circuit by the circulating coolant. An amount of coolant that is too small causes the cooling power to be reduced, in particular causes the compressor lubrication to fail and thus damages the coolant compressor.

The coolant is fed from the collector 23 in the liquid state to the expansion valve 24 which relaxes the coolant as a throttle of the coolant circuit before the coolant is fed to the downstream coolant heat exchanger 25. In the coolant heat exchanger 25, which is also referred to as a vaporizer, heat is exchanged with ventilating air which is preferably fed to the vehicle cabin. During this exchange of heat, this ventilating air in the coolant heat exchanger 25 feeds heat to the coolant. The coolant which is heated in the vaporizer 25 is fed to the intake side of the coolant compressor 21 and delivered by it, as a result of which the coolant circuit is closed.

In the exemplary embodiment of a device according to the invention an external temperature sensor 4 is provided on the vehicle for measuring a temperature in the region of the ambient air of the vehicle, as well as an engine temperature sensor 5 for measuring a cooling water temperature of the drive assembly 7 of the vehicle and a coolant pressure sensor 6 for measuring a coolant pressure. The coolant pressure sensor 6 is preferably arranged on the high pressure side of the coolant circuit (that is, downstream of the coolant compressor 21) and upstream of the expansion valve 24. The sensors are connected to the computer 1 in a way which can be evaluated, said computer 1 also having a drive connection to the coolant compressor 21 and to a warning display 3.

The computer 1 first evaluates at least the signals of the external temperature sensor 4 and of the engine temperature sensor 5 and advantageously reads out the value of the pressure sensor 6 simultaneously or in direct sequence and stores it in a memory. An algorithm which is stored on the computer then forms the difference between the temperature values of the engine temperature sensor 5 and the external temperature sensor 4 and compares this temperature difference with a cooling threshold value. The comparison detects insufficient or sufficient cooling of the drive assembly as an equivalent consideration variable for the thermal homogenization of the vehicle.

When sufficient cooling of the drive assembly is detected, the resting state analysis is carried out as a function of the result of this comparison by reference to a further evaluation and comparison algorithm which is stored on the computer 1, and which calculates one of the two measured temperature values or a difference temperature value which is calculated therefrom and defines a limiting pressure value by reference to this defined equivalent coolant temperature value and at least one limiting pressure curve defined in a temperature/pressure diagram. The coolant pressure value which is measured and stored in the memory is then compared with the limiting pressure value in the evaluation part of the algorithm, and the existence of an incorrect quantity is concluded as a function thereof When an incorrect quantity is detected by this evaluation, delivery operation of the coolant compressor 21 is disabled via the actuation line, and the warning display 3 which informs the user about the incorrect quantity and/or the stopping of the operation of the air conditioning system is switched.

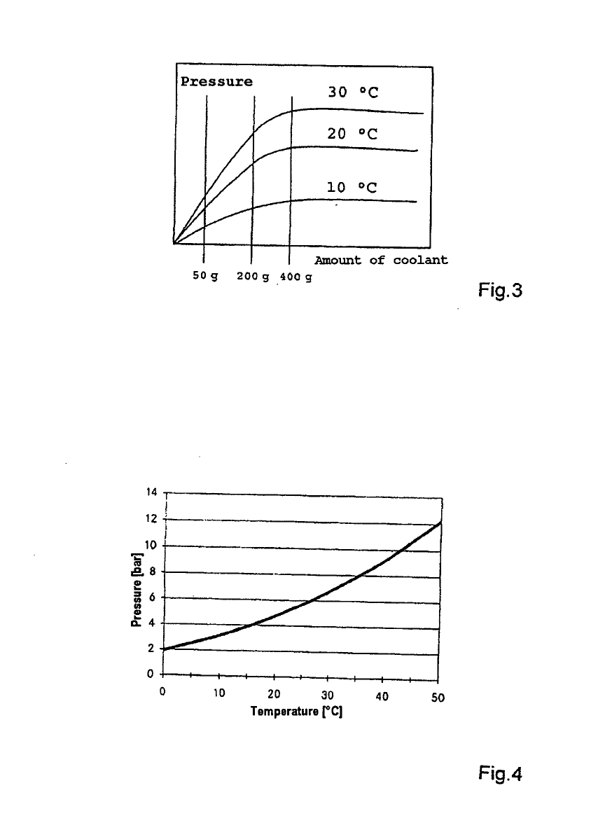

FIG. 3 is a schematic diagram which illustrates the relationship between the coolant quantity and the coolant pressure in an enclosed volume of an, if appropriate, stationary and homogenized coolant circuit. Lines of constant temperatures are illustrated. Above a certain coolant quantity, a fluid component is present in the coolant circuit so that in this range a constant pressure is provided in the coolant circuit at a constant temperature. Below a limiting quantity, the curves of constant temperature have a detectable gradient as a function of the pressure of the coolant quantity. It is thus possible to determine when the coolant quantity drops below a limiting value by monitoring the pressure at a constant and homogenous temperature. The diagram, with its qualitative information about the relationship between the coolant quantity and pressure at constant temperatures, relates to a coolant circuit in the resting state which is homogenized by a corresponding run-on time, that is to say has constant pressure and temperature values in the entire circuit.

FIG. 4 is a quantitative illustration of a pressure limiting curve for the purpose of indicating a minimum coolant pressure in a predefined coolant circuit as a function of the temperature prevailing there, homogenous pressure and temperature values in the entire coolant circuit also being a precondition. This illustrated pressure limiting curve is used to analyze the resting state of an incorrect quantity of the coolant circuit, associated with a reference temperature value. The value of the limiting pressure curve for this temperature is determined as a limiting pressure value, and the latter is used for comparison with the measured temperature value in order to check for a minimum quantity.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1.-13. (canceled)

14. A method for monitoring the filling level of a coolant circuit of a vehicle air conditioning system, said method comprising:
measuring at least one of an external temperature and an engine temperature of the vehicle;
measuring coolant pressure of the coolant circuit;
performing a resting state analysis of the coolant quantity based on a relationship between a measured temperature value and the measured coolant pressure;
detecting an incorrect filling level based on a result of said resting state analysis; and
controlling operation of at least one of the coolant circuit and warning events when an incorrect filling level is detected; wherein,
a homogenous thermal state of the vehicle is detected by one of i) expiration of a defined time period and ii) as a function of at least one measured temperature (tₐ, tₘ); and
the resting state analysis is carried out, or control events during operation of the coolant circuit and/or warning events in the vehicle are controlled, as a function of the detected homogenous thermal state of the vehicle.

15. The method as claimed in claim 14, wherein the homogenous thermal state is defined by defining a homogenous thermal point in time, or a duration necessary to reach a homogenous thermal state, as a function of the external temperature.

16. The method as claimed in claim 14, wherein the homogenous thermal state is defined by defining a homogenous thermal point in time, or a duration necessary to reach a homogenous thermal state, as a function of the engine temperature.

17. The method as claimed in claim 14, wherein a homogenous thermal point in time, or a duration necessary to reach a homogenous thermal state, is defined directly after a vehicle drive assembly has been shut down.

18. The method as claimed in claim 14, wherein the homogenous thermal point in time, or a duration necessary to reach a homogenous thermal state, is defined in a stationary state of the vehicle continuously or repetitively whenever a time interval has expired.

19. The method as claimed in claim 14, wherein the homogenous thermal state of the vehicle is detected by means of a homogenization analysis in which a relationship between the engine temperature and the external temperature is evaluated.

20. The method as claimed in claim 17, wherein the homogenization analysis is carried out directly before the vehicle drive assembly is put into operation, after one of a locking system, starting system, and an activation device of the vehicle has been actuated.

21. Apparatus for monitoring a filling level of a coolant circuit of a vehicle air conditioning system, said apparatus comprising:
a computer, which is coupled to intervene in a controlling fashion with at least one of the coolant circuit and warning devices; and
at least one sensor for measuring at least one of an external temperature and an engine temperature, and a coolant pressure sensor, each of said sensors being connected to the computer in such a way that its output can be evaluated; wherein,
said computer has an algorithm stored therein for carrying out a resting state analysis for detecting an incorrect filling level of the coolant circuit based on a relationship between measured coolant pressure and a measured temperature value, and for switching control interventions for at least one of the coolant circuit and warning events when an incorrect filling level is detected;
thermal homogenization of the vehicle is detected by an algorithm that is stored on the computer, based on at least one of a measured value of the external temperature and a measured value of engine temperature; and
the resting state analysis is carried out, and/or the warning events or control events are switched, as a function of the detection of thermal homogenization.

22. The device as claimed in claim 21, wherein an algorithm stored on the computer detects a homogenous thermal state of the vehicle as a function of one of i) a defined time or point in time period, and ii) measured temperature values.

23. The device as claimed in claim 21, wherein a definition algorithm of the defined time, point in time or duration can be activated directly after the drive assembly has been shut down, as a result of the shutting down of the drive assembly or an event which is connected with it.

24. The device as claimed in claim 21, wherein the definition algorithm is active continuously or on an interval basis while the vehicle is stationary.

25. The device as claimed in claim 21, wherein an algorithm stored on the computer detects thermal homogenization of the vehicle by reference to a difference between measured values of external temperature sensor and engine temperature.

26. The device as claimed in claim 14, wherein the computer is connected to at least one of a locking system, a starting system and a system activation device of the vehicle, and can be activated when said device is opened, started or activated.
